(19) United States
(12) Patent Application Publication
(10) Pub. No.: US 2007/0216528 A1
(43) Pub. Date: Sep. 20, 2007

(54) Operation support system, sending device, and receiving device

(75) Inventors: Norio Sanma, Okazaki-city (JP); Masakazu Kagawa, Inuyama-city (JP); Yasuo Yoshikawa, Nishikamo-gun (JP)

Correspondence Address: HARNESS, DICKEY & PIERCE, P.L.C., P.O. BOX 828, BLOOMFIELD HILLS, MI, 48303, US

(73) Assignees: DENSO Corporation, Aichi-pref. (JP); NIPPON SOKEN, INC., Aichi-pref. (JP)

(21) Appl. No.: 11/711,189

(22) Filed: Feb. 26, 2007

(30) Foreign Application Priority Data
Mar. 9, 2006 (JP) 2006-64299

(51) Int. Cl. G08B 29/00; B60Q 1/00; H04J 3/06; G08B 1/00; G08G 1/123

(52) U.S. Cl. 340/506; 370/518; 340/425.5; 340/531; 340/988

(57) ABSTRACT

When a map screen is displayed in a navigation system of a subject vehicle, a position of any other vehicle is estimated and is displayed in the map screen. Influence of delay due to the following is eliminated or reduced: time consumed in processing in a navigation system of the other vehicle; time consumed in communication between the navigation system of the other vehicle and the navigation system of the subject vehicle; time from when the navigation system of the subject vehicle receives communication information to when it generates information to be notified; and the like. In cases where the influence of delay is taken into account, as mentioned above, accuracy of a notified position of the other vehicle is enhanced. Thus, an accurate operation support system is provided to minimize occurrence of errors.

### CROSS REFERENCE TO RELATED APPLICATION

This application is based on and incorporates herein by reference Japanese Patent Application No. 2006-64299 filed on Mar. 9, 2006.

### FIELD OF THE INVENTION

The present invention relates to an operation support system and the like that support a driver in a place, such as an intersection, where the driver should pay particular attention.

### BACKGROUND OF THE INVENTION

As conventional art, there are known the techniques disclosed in Patent Document 1 and Patent Document 2 below.

The technique disclosed in Patent Document 1 relates to a system that can notify vehicles present nearby of traffic conditions or the like on a road or at an intersection even when such an infrastructure as roadside camera and traffic management center has not been provided. Specifically, this system picks up an image of the surrounding area at each vehicle and detects the traffic conditions or any unusual situation around the vehicle from the picked-up image. Then, the system transmits the result of detection to another vehicle by radio. Thus, it can accomplish operation support even in a situation where a high-cost infrastructure has not been provided.

The technique disclosed in Patent Document 2 relates to a system for position detection utilizing GPS. Even when a radio wave from a GPS satellite is blocked by a nearby building or the like, the system can carry out position detection with accuracy. Specifically, a quasi-satellite is installed in a place where it is difficult to capture a GPS satellite, such as urban area, underground, and underneath an elevated structure. Thus, it is made possible to constantly acquire four or more satellite radio waves, and the accuracy of position detection is thereby enhanced.

Patent Document 1: JP-2001-283381 A

Patent Document 2: JP-2003-296882 A

The techniques disclosed in Patent Document 1 and Patent Document 2 will of course contribute to the proliferation of operation support systems or enhance the usability of operation support systems. However, they have not been sufficient in the accuracy of information notified to drivers. Specific description will be given. These techniques do not give consideration to time consumed in vehicle-to-vehicle communication or in the internal processing in each piece of equipment. This results in large errors.

For example, commercialization of wireless LANs (e.g., IEEE 802.11b, etc.) as a radio communication method has been presently considered. In general, wireless LANs are based on CSMA/CA and thus real time property is not sufficiently guaranteed in wireless LANs. More specific description will be given. In CSMA/CA, a node (device) that desires to transmit data monitors the situation of communication in a communication path, and starts transmission when the communication path becomes unoccupied. If multiple nodes simultaneously start transmission at this time, data collides with another data in the communication path and is destructed. A node that encountered collision aborts transmission, and waits for a random time and then restarts transmission. Therefore, it cannot be said that real time property is sufficiently guaranteed in wireless LANs.

Even if the presence of any obstacle is detected with millimeter-wave radar, there is a problem. After a reflected wave is obtained at a receiving section, some time is required for the millimeter-wave radar device to analyze the obtained reflected wave and recognize the presence of the obstacle. In cases where the result of recognition is used only in a vehicle mounted with the millimeter-wave radar device, this time may be an insignificant error. However, it also takes some time to transmit a signal indicating the presence of the obstacle to another vehicle and let the driver of that vehicle know it. When this is considered, time required for the millimeter-wave radar device to recognize an obstacle should not be disregarded in terms of overall error reduction.

### SUMMARY OF THE INVENTION

The invention has been made with the above-mentioned problems taken into account. It is an object of the invention to provide an accurate operation support system in which occurrence of an error is minimized.

According to an aspect of the present invention, an operation support system is provided as follows. The system includes a sending device and a receiving device. The sending device includes (1) a situation information acquisition unit configured to acquire information on a situation around the sending device as situation information; (2) a first communication unit configured to communicate with the receiving device; and (3) a first control unit configured to (i) manage a clock time, (ii) add clock time information to identify a true clock time, which is associated with the acquired situation information, to the acquired situation information to compose communication information, and (iii) cause the first communication unit to transmit the composed communication information to the receiving device. The receiving device includes (1) a notifying unit configured to give notification of information; (2) a second communication unit configured to communicate with the sending device to receive the communication information from the sending device; and (3) a second control unit configured to (i) manage a clock time, (ii) make an estimation of situation information at a current clock time from the situation information contained in the received communication information, based on an elapsed time from the true clock time identified by the clock time information contained in the received communication information, and (iii) cause the notifying unit to give notification of the estimated situation information.

That is, an operation support system of the invention estimates situation information at the present time and thereby eliminates or reduces the influence of delay due to the following: time consumed in processing in the sending device; time consumed in communication between the sending device and the receiving device; time from when the receiving device receives situation information to when it starts estimation; and the like. The true clock time associated wit the situation information does not refer to a clock time when that situation was detected with a sensor or the like or a clock time when the situation was recognized based on information from the sensor or the like. It refers to a clock time when the situation itself arose. An in-vehicle camera will be taken as an example. The time when a bicycle, which lunged in front of the subject vehicle, ran over the center line on the road is a true clock time. The clock time when the image pickup device (e.g., CCD) of the in-vehicle camera captured the situation in which the bicycle ran over the center line on the road and outputted it as a video signal or the clock time when the CPU analyzed that video signal and recognized the presence of the bicycle is not the “true clock time” cited here. However, in cases where these clock times are compared with the true clock time (the clock time when the bicycle ran over the center line on the road) and there is only a time difference to the extent that they may be considered as substantially identical, these clock times may be handled as true clock times. The “clock time” managed by each control unit may be an ordinary clock time, that is, such a clock time as “1 o'clock 23 minutes 45 seconds” or may be a count accumulated from some base point in time.

Therefore, in cases where the influence of delay is taken into account, as mentioned above, the accuracy of notified situation information can be enhanced more than ever.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating the general configuration of an automobile navigation system;

FIG. 2 is a flowchart explaining the transmission processing carried out by an automobile navigation system;

FIGS. 3A to 3E are data format diagrams explaining communication information transmitted by an automobile navigation system;

FIG. 4 is a flowchart explaining interrupt handling carried out by an automobile navigation system;

FIG. 5 is a flowchart explaining reception processing carried out by an automobile navigation system;

FIG. 6 is an explanatory drawing explaining a map screen displayed on a display unit in Prior Art;

FIGS. 7 and 8 are explanatory drawings explaining a map screen displayed on a display unit;

FIG. 9 is a block diagram illustrating the general configuration of a roadside machine;

FIG. 10 is a flowchart explaining transmission processing carried out by a roadside machine;

FIG. 11 is a data format diagram explaining communication information transmitted by a roadside machine; and

FIG. 12 is a flowchart explaining interrupt handling carried out by a roadside machine.

### DETAILED DESCRIPTION OF THE PREFERRED EMBODIMENTS

Hereafter, description will be given to an embodiment to which the invention is applied with reference to drawings. The manner in which the invention is embodied is not limited to the following embodiment, and the invention can be embodied in various manners without departing from the technical scope of the invention.

Description of Configuration

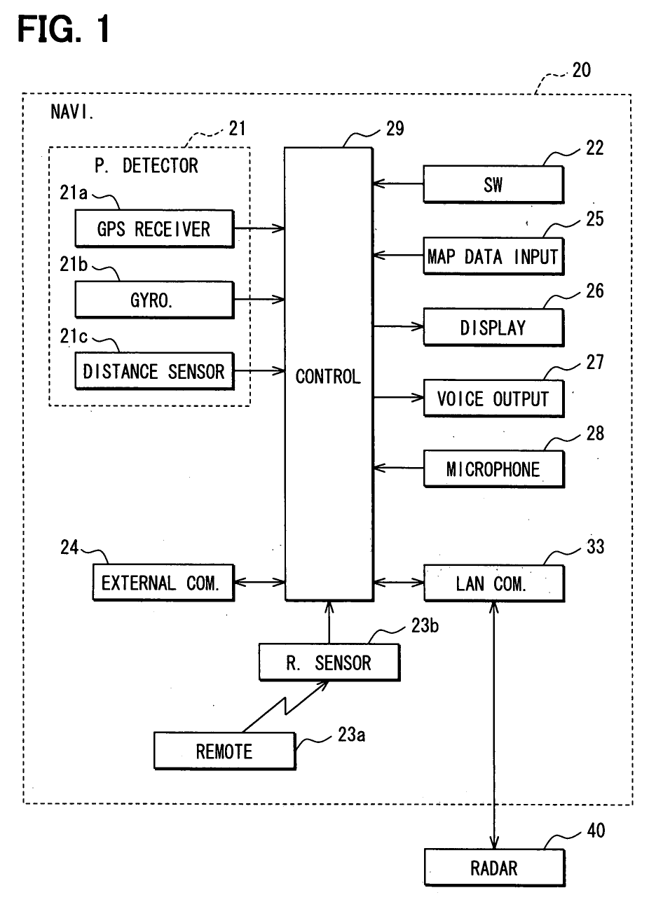

FIG. 1 is a block diagram illustrating the general configuration of an automobile navigation system 20 in which the functions of the sending device and receiving device of the invention are incorporated.

The automobile navigation system 20 is mounted in a subject vehicle, and includes: a position detector 21 that detects the current position of the vehicle; an operation switch group 22 for inputting various instructions from the user; a remote control terminal (hereafter, referred to as remote) 23a that is capable of inputting various instructions like the operation switch group 22 and is separate from the automobile navigation system 20; a remote sensor 23b for inputting signals from the remote 23a; an external communication instrument 24 that is connected to a packet telecommunication network or the like and communicates with external sources; a map data input device 25 for inputting data from map storage media with map data, voice data, or the like recorded thereon; a display unit 26 for displaying maps and various information; a voice output unit 27 for outputting various audio guidance and the like; a microphone 28 that outputs electrical signals based on voice given out by the user; an in-vehicle LAN communication unit 33 that communicates with various ECUs connected with an in-vehicle LAN; a control unit 29 that carries out various processing according to inputs from the above-mentioned position detector 21, operation switch group 22, remote sensor 23b, external communication instrument 24, map data input device 25, microphone 28, and in-vehicle LAN communication unit 33 and controls the external communication instrument 24, display unit 26, voice output unit 27, and in-vehicle LAN communication unit 33.

The position detector 21 includes: a GPS receiver 21a that receives radio waves from artificial satellites for GPS (Global Positioning System) through a GPS antenna, not shown, and outputs reception signals; a gyroscope 21b that detects the magnitude of rotational motion applied to the vehicle; and a distance sensor 21c for detecting the distance traveled by the vehicle from the acceleration of the vehicle in the longitudinal direction and the like. The control unit 29 computes the position, orientation, speed, and the like of the vehicle based on output signals from the sensor and the like 21a to 21c. There are various methods for determining the current position based on output signals from the GPS receiver 21a. The point positioning method or the relative positioning method may be adopted.

The operation switch group 22 is constructed of: a touch panel constructed integrally with the display surface of the display unit 26; mechanical key switches provided around the display unit 26; and the like. The touch panel and the display unit 26 are laminated and integrated with each other. There are various types of touch panel, pressure sensing type, electromagnetic induction type, capacitance type, and combinations of them. Any of them may be used.

The remote 23a is constructed of multiple buttons. It is so constructed that when any button is pressed, a signal corresponding to the nature of that button is transmitted to the remote sensor 23b by short-range radio communication by infrared rays or the like.

The remote sensor 23b is so constructed as to receive signals sent from the remote 23a and output the received signals to the control unit 29.

The external communication instrument 24 takes on the function of carrying out short-range radio communication with other automobile navigation systems, and utilizes, for example, wireless LAN (IEEE 802.11b/g).

The map data input device 25 is used to input various data stored on map data storage media (e.g., hard disk, DVD-ROM, etc.). On map data storage media, there are stored map data (node data, link data, cost data, background data, road data, name data, mark data, intersection data, facility data, operation support area data, etc.), voice data for guidance, voice recognition data, and the like. Instead of inputting these data from map data storage media, these data may be inputted through a communication network. The operation support area data is information for identifying areas, such as intersections and junctions, where accidents relatively frequently occur, and is composed of the latitudinal coordinate and longitudinal coordinate of each apex of each such area.

The display unit 26 is constructed of a liquid crystal display, organic EL display, or the like. The following can be displayed in superposition in the display screen of the display unit 26: a mark that indicates the present location identified from the current position of the vehicle identified by the position detector 21 and map data inputted from the map data input device 25; a directed route to a destination; additional data such as names, landmarks, and marks for various facilities. The display unit is also capable of displaying facility guide and the like.

When the user inputs (gives out) his/her voice or speeches, the microphone 28 outputs an electrical signal (audio signal) based on the inputted voice to the control unit 29. The user can operate the automobile navigation system 20 by inputting various speeches to the microphone 28.

The in-vehicle LAN communication unit 33 is responsible for communication with various ECUs (engine ECU, AT-ECU, brake ECU, etc.), not shown, connected with the in-vehicle LAN, various sensors (turn signal lamp sensor, speed sensor, door open and close sensors, etc.), not shown, and a millimeter-wave radar device 40. The millimeter-wave radar device 40 is so constructed that the following is implemented: a millimeter-wave is sent out from a transmission unit (not shown) installed at the front end of the vehicle; a reception unit installed at the rear end of the vehicle receives a reflected wave from an object ahead; and the state of the presence of the object ahead of the vehicle is thereby grasped. The millimeter-wave radar device is so constructed that the state of the presence of an object ahead of the vehicle is outputted as vehicle's front situation data (i.e., data on situation ahead of vehicle) to the automobile navigation system 20.

The control unit 29 is constructed based on a publicly known microcomputer composed of CPU, ROM, RAM, SRAM, I/O, bus lines that connect these items, and the like, and carries out various processing based on programs stored in the ROM and the RAM. For example, the control unit 29 carries out present location display processing, route computation processing, route guide processing, and the like. In present location display processing, the control unit 29 computes the current position of the vehicle as a set of coordinates and a traveling direction based on corresponding signals from the position detector 21 and causes the display unit 26 to display a map of the area in proximity to the current position, read through the map data input device 25, and the like. In route computation processing, the control unit 29 computes the optimum route from the current position to a destination based on the following: map data stored in the map data input device 25; and the destination set according to the operation of the operation switch group 22, remote 23a, or the like. In route guide processing, the control unit 29 causes the display unit 26 to display the computed route or the voice output unit 27 to output it by voice.

Description of Operation

Description will be given to the transmission processing, interrupt handling, and reception processing carried out by the control unit 29. With respect to transmission processing and reception processing, the control unit 29 may be so constructed that it carries out only either of them. Other processing, for example, current position display processing, route computation processing, route guide processing, or the like, carried out by the control unit 29 is widely known common processing; therefore, the description of them will be omitted.

(1) Transmission Processing

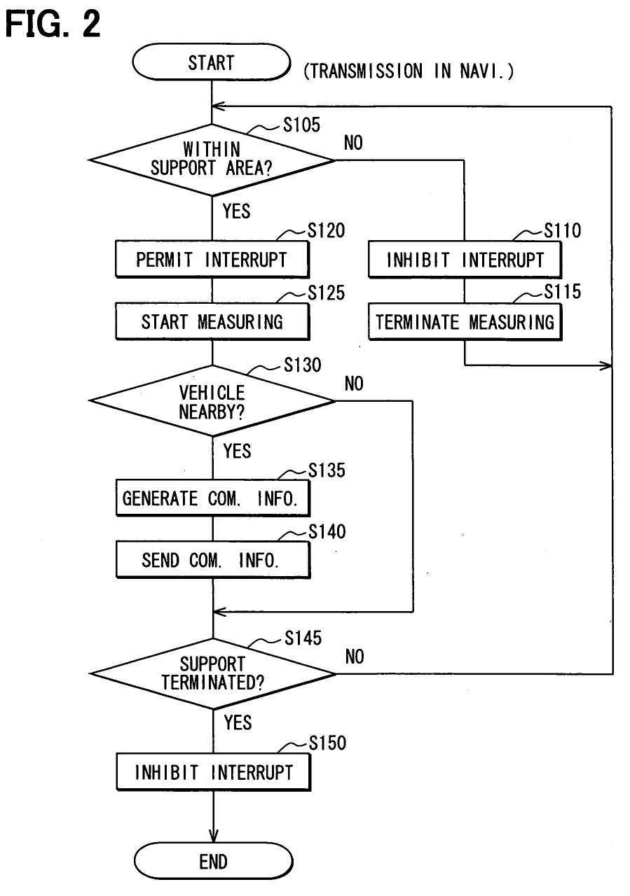

First, description will be given to the transmission processing carried out by the control unit 29 with reference to the flowchart in FIG. 2. The execution of transmission processing is started when power supply to the automobile navigation system 20 is initiated.

After starting the execution of transmission processing, the control unit 29 first determines whether or not the current position is within an operation support area (S105). This determination is carried out based on the current position of the vehicle identified based on a signal from the position detector 21 and operation support area data read from map data storage media through the map data input device 25. That is, this step is carried out to determine whether or not the current position of the vehicle is a place set as an operation support area. In cases where the control unit 29 determines that the current position is within an operation support area (S105: Yes), it proceeds to S120. In cases where the control unit 29 determines that the current position is not within an operation support area (S105: No), it proceeds to S110.

At S110, to which the control unit 29 proceeds when it determines that the current position is not within an operation support area, it inhibits an interruption for the reception of reference clock time information. This is done by bringing a flag indicating whether or not interrupt handling is executable, provided in the control unit 29, into a state of “not executable.”

In cases where the measuring operation, described later, is being performed, the control unit 29 subsequently terminates the measuring operation (S115), and returns to S105.

At S120, to which the control unit 29 proceeds when it determines that the current position is within an operation support area, the control unit 29 permits an interruption for the reception of reference clock time information. This is done by bringing the flag indicating whether or not interrupt handling is executable, provided in the control unit 29, into a state of “executable.”

Subsequently, the control unit 29 starts measuring operation (S125). This is done by sending an instruction to start the operation to the millimeter-wave radar device 40, and starts the reception of vehicle's front situation data outputted from the millimeter-wave radar device 40.

Subsequently, the control unit 29 determines whether or not any other vehicle is present nearby (S130). This is done by analyzing vehicle's front situation data obtained from the millimeter-wave radar device 40. In cases where in addition to the millimeter-wave radar device 40, the vehicle is mounted with some other device (e.g., camera, sonar, etc.) capable of grasping the state of an object present beside or behind the vehicle, information from such a device may also be used in determination. In cases where the control unit 29 determines at S130 that some other vehicle is present nearby (S130: Yes), it proceeds to S135. In cases where the control unit 29 determines that any other vehicle is not present nearby (S130: No), it proceeds to S145.

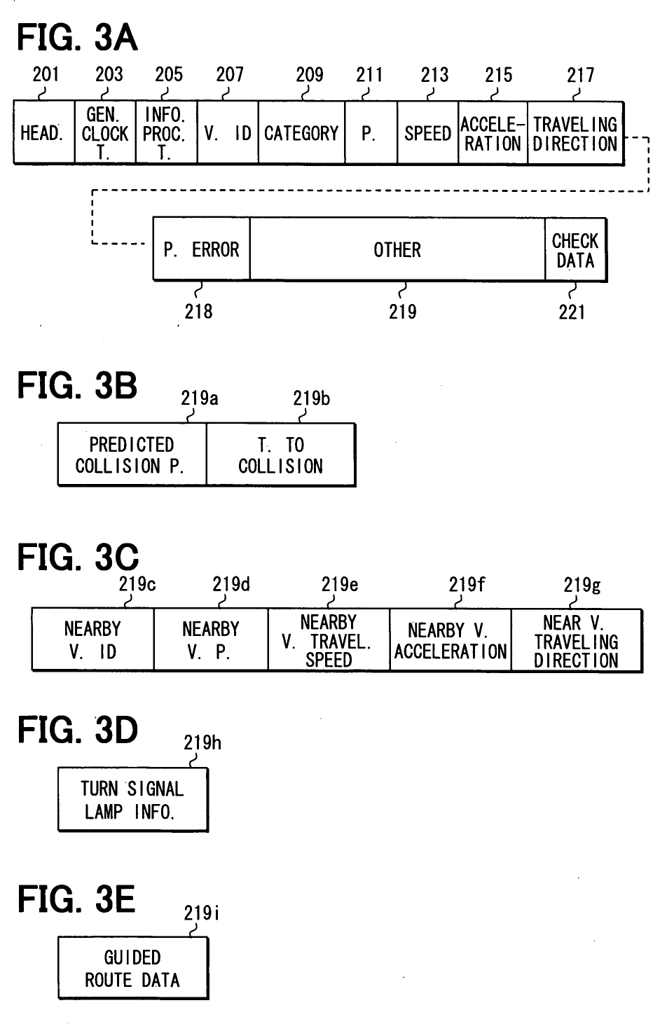

At S135, to which the control unit 29 proceeds when it determines that some other vehicle is present nearby, the control unit 29 generates communication information for transmission. The communication information includes information on the position of the subject vehicle, information on the situation ahead of the subject vehicle detected by the subject vehicle, and the like. This communication information is transmitted to another vehicle nearby. Description will be given to examples of this communication information with reference to the data format diagrams in FIGS. 3A to 3E.

FIG. 3A is a data format diagram illustrating the entire communication information. The communication information is composed of header 201, clock time of generation 203, transmission information processing time 205, transmitting vehicle ID 207, transmitting vehicle category 209, transmitting vehicle position 211, transmitting vehicle speed 213, transmitting vehicle acceleration 215, transmitting vehicle traveling direction 217, transmitting vehicle position error 218, other data 219, and check data 221.

The header 201 is composed of information required in terms of protocol, information for identifying that the relevant information is communication information, and the like.

The clock time of generation 203 is the clock time when the relevant communication information was generated (more precisely, the clock time at the base point i in time, described later).

The transmission information processing time 205 is the time that lapsed after the point in time when the control unit 29 received vehicle's front situation data to be used to generate the relevant communication information from the millimeter-wave radar device 40 before the point in time (base point i in time) when the control unit 29 processed the vehicle's front situation data and actually set it in the communication information. It is advisable to further add the time of processing in the millimeter-wave radar device 40 to this elapsed time. These time periods may be actually measured, or predetermined certain time may be used as these time periods if that time does not vary so much.

The transmitting vehicle ID 207 is a unique ID for identifying the subject vehicle, and, for example, the index number of the vehicle, a random number, or the like can be used as this ID.

The transmitting vehicle category 209 is information indicating the category (heavy duty vehicle, ordinary-sized motor vehicle, motorcycle, etc.) of the subject vehicle.

The transmitting vehicle position 211 is information indicating the latitude and longitude of the center point of the subject vehicle, and the current position information identified based on a signal from the position detector 21 is used as this data. The altitude may be included in this data.

The transmitting vehicle speed 213 is the traveling speed of the subject vehicle, which is information obtained from the speed sensor, not shown, through the in-vehicle LAN communication unit 33.

The transmitting vehicle acceleration 215 is the acceleration of the subject vehicle, which is information obtained from the gyroscope 21b.

The transmitting vehicle traveling direction 217 is information indicating the direction of the subject vehicle, represented by a clockwise angle with the due north taken as 0 degrees. This is also information obtained from the gyroscope 21b.

The transmitting vehicle position error 218 is an error in the current position identified based on a signal obtained from the position detector 21. It is composed of an error in the latitudinal direction and an error in the longitudinal direction. A predetermined value may be used as this data, or it may be determined by computation using some technique.

The other data 219 includes data obtained by processing vehicle's front situation data received from the millimeter-wave radar device 40 and data indicating various information inputted through the in-vehicle LAN communication unit 33. The details of the other data will be described later.

The check data 221 is used on the receiving side to confirm that communication information was properly transmitted and received. Communication information is determined to have been properly transmitted and received when it is confirmed that the data, obtained by applying the communication information excluding the check data 221 to a predetermined computational expression, agrees with the check data 221 on the receiving side.

Description will be given to some examples of the other data 219.

FIG. 3B is a data format diagram of an example of the other data 219. The other data illustrated in FIG. 3B is composed of predicted collision position 219a and time to collision 219b.

The predicted collision position 219a is information indicating the predicted position of collision between the subject vehicle and another vehicle ahead of the vehicle. This information is obtained by the following procedure. Situation ahead of vehicle data obtained from the millimeter-wave radar device 40 is processed to determine a certain vehicle that can collide with the subject vehicle. Then, the collision position is computed from information such as the position, traveling speed, and the like of the certain vehicle and information such as the position, traveling speed, and the like of the subject vehicle. Thus, the above-mentioned information is obtained. In cases where there is no vehicle that can collide with the subject vehicle, information indicating the absence of such a vehicle is set as the predicted collision position 219a.

The time to collision 219b is the time to the above-mentioned collision, or the time it takes for the subject vehicle to arrive at the above-mentioned predicted collision position. This time is equivalent to the time from the above-mentioned base point i in time.

FIG. 3C is a data format diagram of another example of the other data 219. The other data illustrated in FIG. 3C is composed of nearby vehicle ID 219c, nearby vehicle position 219d, nearby vehicle traveling speed 219e, nearby vehicle acceleration 219f, and nearby vehicle traveling direction 2199.

The nearby vehicle ID 219c is information for uniquely identifying one of vehicles present in proximity to the subject vehicle. The vehicle is identified by processing vehicle's front situation data obtained from the millimeter-wave radar device 40 or carrying out communication with the same automobile navigation system mounted in the other vehicle. Possible concrete examples of the information include the index number of the vehicle, a random number, or the like.

The nearby vehicle position 219d is information on the position of the vehicle corresponding to the information set as the nearby vehicle ID 219c. Specifically, it is information indicating the latitude and longitude of the center point of the vehicle. It is obtained by processing vehicle's front situation data obtained from the millimeter-wave radar device 40. The altitude may be included in this data.

The nearby vehicle traveling speed 219e is the traveling speed of the vehicle corresponding to the information set as the nearby vehicle ID 219c. This is also obtained by processing vehicle's front situation data obtained from the millimeter-wave radar device 40.

The nearby vehicle acceleration 219f is information about the acceleration of the vehicle corresponding to the information set as the nearby vehicle ID 219c. This is also obtained by processing vehicle's front situation data obtained from the millimeter-wave radar device 40.

The nearby vehicle traveling direction 219g is information indicating the direction of the vehicle corresponding to the information set as the nearby vehicle ID 219c, which is represented by a clockwise angle with the due north taken as 0 degrees. This is also obtained by processing vehicle's front situation data obtained from the millimeter-wave radar device 40.

In cases where multiple vehicles are present in proximity to the subject vehicle, it is advisable to generate multiple sets of information of the nearby vehicle ID 219c to the nearby vehicle traveling direction 219g and set all the multiple sets of information as the other data 219.

FIG. 3D is a data format diagram of another example of the other data 219. The other data illustrated in FIG. 3D is composed of turn signal lamp information 219h. The turn signal lamp information 219h is obtained from a turn signal lamp sensor through the in-vehicle LAN communication unit 33, and indicates which turn signal lamp, right or left, is operating or that neither turn signal lamp is operating.

FIG. 3E is a data format diagram of another example of the other data 219. The other data illustrated in FIG. 3E is composed of guided route data 219i. The guided route data 219i is information about guided routes and is composed of information of nodes and links composing each guided route and the like. When a route guide is not being provided, information indicating that is set as the guided route data 219i.

Aside from the foregoing, for example, the following may be set as the other data 219: information related to the shift position of the subject vehicle; information related to the state of operation of a hazard warning flashing lamp; information indicating whether or not emergency running is being carried out when the subject vehicle is an emergency vehicle; information indicating that the subject vehicle is a commercial vehicle, if so; information related to the state of brake operation of the subject vehicle; and a message (e.g., “Go ahead,” “Thank you,” “Hello,” “Goodbye,” “I will pull into traffic,” “I will go through,” “I will slow down because of traffic jam,” etc.) inputted or selected by an occupant.

Description will be returned to FIG. 2. After the completion of generation of the communication information for transmission, the control unit 29 transmits the generated communication information to nearby vehicles through the external communication instrument 24 (S140). This is done by broadcast.

At S145, subsequently, the control unit 29 determines whether or not an instruction to terminate operation support has been accepted (S145). That is, the control unit 29 determines whether or not an instruction to terminate operation support, given by the user operating the operation switch group 22 or the remote 23a, has been accepted. In cases where the control unit 29 determines that an instruction to terminate operation support has been accepted (S145: Yes), it proceeds to S150. In cases where the control unit 29 determines that an instruction to terminate operation support has not been accepted (S145: No), it returns to S105.

At S150, to which the control unit 29 proceeds when it determines that an instruction to terminate operation support has been accepted, the control unit 29 terminates the measuring operation started at S125, and further inhibits an interruption for the reception of reference clock time information (S150). Inhibiting an interruption for the reception of reference clock time information refers to bringing the flag indicating whether or not interrupt handling is executable, provided in the control unit 29, into a state of “not executable.” After the completion of these steps, the control unit 29 terminates this processing (transmission processing).

(2) Interrupt Handling

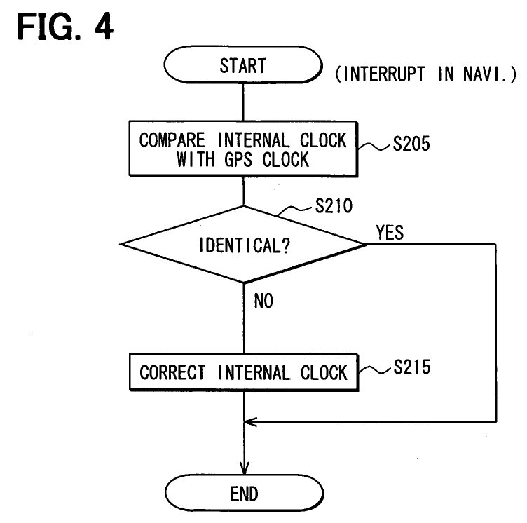

Description will be given to the interrupt handling carried out by the control unit 29 with reference to the flowchart in FIG. 4. The execution of interrupt handling is started when the GPS receiver 21a receives GPS information including a clock time and this information is inputted as an interrupt signal to the control unit 29. The interrupt handling is executed only when the flag indicating whether or not interrupt handling is executable, provided in the control unit 29, is in a state of “executable.”

After starting the execution of interrupt handling, the control unit 29 takes the clock time in the satellite out of the GPS information that triggered this processing, and compares it with the internal clock of the control unit 29 (S205).

Subsequently, the control unit 29 determines whether or not the clock time on the internal clock of the control unit 29 is identical with the received clock time in the satellite (S210). In cases where the control unit 29 determines that the clock times are identical with each other (S210: Yes), it terminates this processing (interrupt handling). In cases where the control unit 29 determines that the clock times are not identical with each other (S210: No), it proceeds to S215.

At S215, to which the control unit 29 proceeds when it determines that the clock time on the internal clock of the control unit 29 and the received clock time in the satellite are not identical with each other, the control unit 29 corrects (updates) the clock time on the internal clock of the control unit 29 with the received clock time in the satellite. In other words, this step functions as a clock time synchronizing unit. Then, the control unit 29 terminates this processing (interrupt handling).

(3) Reception Processing

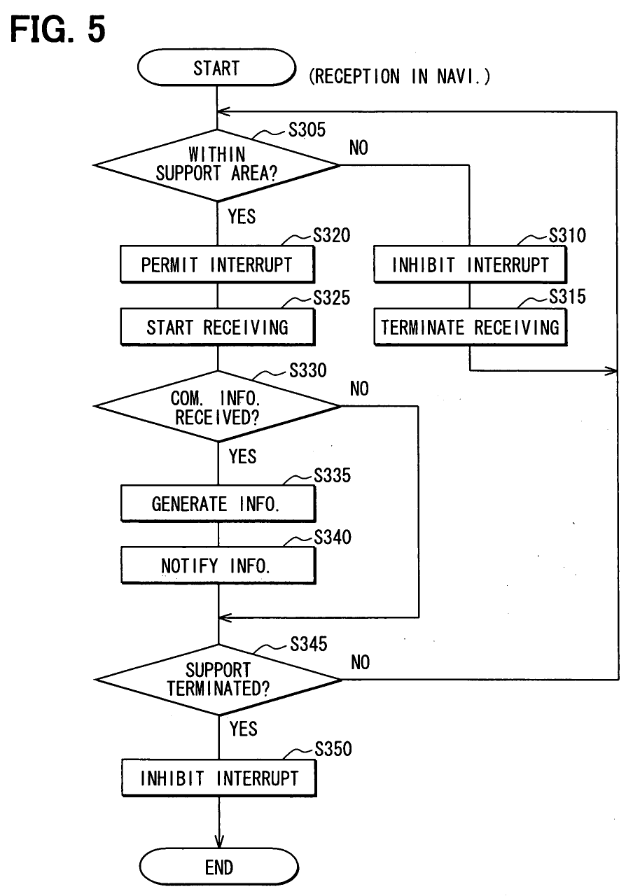

Description will be given to the reception processing carried out by the control unit 29 with reference to the flowchart in FIG. 5. The execution of reception processing is started when power supply to the automobile navigation system 20 is initiated.

After starting the execution of reception processing, the control unit 29 first determines whether or not the current position is within an operation support area (S305). This determination is carried out based on the current position of the vehicle identified based on a signal from the position detector 21 and operation support area data read from map data storage media through the map data input device 25. That is, this step is carried out to determine whether or not the current position of the vehicle is a place set as an operation support area. In cases where the control unit 29 determines that the current position is within an operation support area (S305: Yes), it proceeds to S320. In cases where the control unit 29 determines that the current position is not within an operation support area (S305: No), it proceeds to S310.

At S310, to which the control unit 29 proceeds when it determines that the current position is not within an operation support area, the control unit 29 inhibits an interruption for the reception of reference clock time information. This is done by bringing the flag indicating whether or not interrupt handling is executable, provided in the control unit 29, into a state of “not executable.”

In cases where the receiving operation, described later, is being performed, the control unit 29 subsequently terminates the receiving operation (S315), and returns to S305.

At S320, to which the control unit 29 proceeds when it determines that the current position is within an operation support area, the control unit 29 permits an interruption for the reception of reference clock time information. This is done by bringing the flag indicating whether or not interrupt handling is executable, provided in the control unit 29, into a state of “executable.”

Subsequently, the control unit 29 starts receiving operation (S325). This is done by enabling the functions of the external communication instrument 24 and bringing it into a state in which it waits for communication information transmitted from another automobile navigation system.

Subsequently, the control unit 29 determines whether or not the external communication instrument 24 has received communication information (S330). In cases where it determines that the external communication instrument has received communication information (S330: Yes), it proceeds to S335. In cases where it determines that the external communication instrument has not received communication information (S330: No), it proceeds to S345.

At S335, to which the control unit 29 proceeds when it determines that communication information has been received, the control unit 29 generates presented information from the communication information. The presented information is information to be presented to the user, generated using received communication information. Here, description will be given to the generation of the position of a transmitting vehicle, one of presented information.

First, transmission information processing time 205 and a clock time of generation 203 are extracted from received communication information. These are applied to Expression 1 to determine total delay time.

Total delay time=Transmission information processing time+(Current clock time−Clock time of generation)+Display processing time Expression 1:

Thus, in Expression 1, the extracted transmission information processing time 205 is used for the transmission information processing time; the current clock time on the internal clock provided in the control unit 29 is used for the current clock time; the extracted clock time of generation 203 is used for the clock time of generation; and the time it takes after the current clock time for information to be finally displayed on the display unit 26 is used for the display processing time. It is advisable to take the actual display processing time in the past and the like into account when determining a display processing time.

Substantially, the total delay time determined by Expression 1 is applied to Expression 2 to determine a travel distance.

Travel distance=(1/2×Acceleration×Total delay timê2)+(Vehicle speed×Total delay time) Expression 2:

The transmitting vehicle acceleration 215 contained in received communication information is used for the acceleration, and the transmitting vehicle speed 213 contained in the received communication information is used for the vehicle speed. It is advisable to divide a travel distance into a component in the X direction (e.g., east direction) and a component in the Y direction (e.g., north direction) when determining the travel distance.

Subsequently, the travel distance determined by Expression 2 is applied to Expression 3 to determine the current position of the transmitting vehicle.

Current position of transmitting vehicle=Old position of transmitting vehicle+Travel distance Expression 3:

The transmitting vehicle position 211 contained in received communication information is used for the old position of the transmitting vehicle. It is also advisable to divide the current position of the transmitting vehicle into a component in the X direction (e.g., east direction) and a component in the Y direction (e.g., north direction) when determining it.

In cases where information about any vehicle other than the transmitting vehicle is contained in the received communication information (Refer to FIG. 3C.), the current position of each vehicle is computed by the same method as mentioned above.

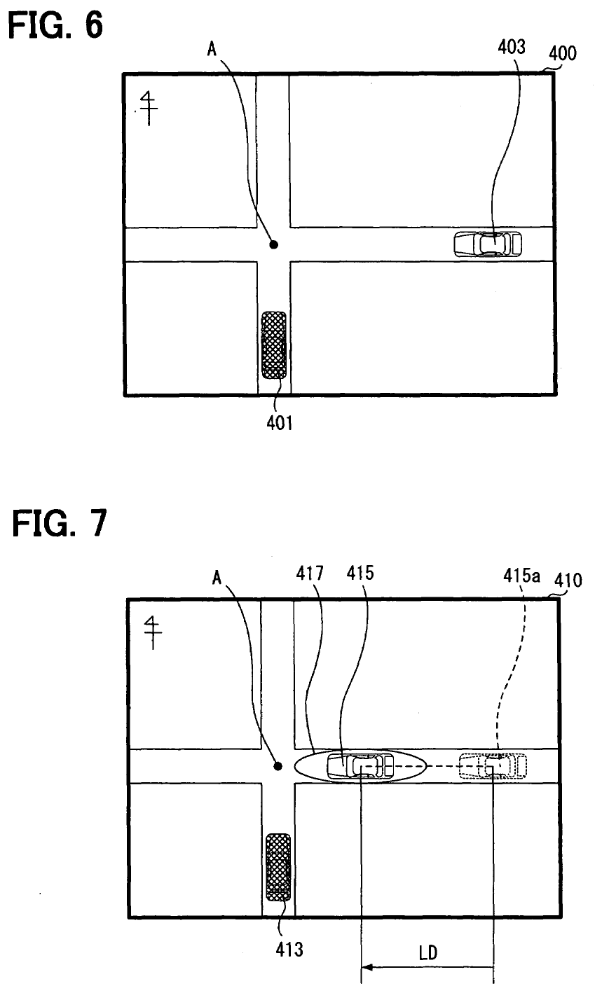

Description will be returned to FIG. 5. Subsequently, the control unit 29 causes the display unit 26 to output a map screen based on the presented information generated at S335 (S340). Here, description will be given to the map screen the display unit 26 is caused to output with reference to FIGS. 6 and 7, based on comparison with a conventional map screen.

The map screen 400 illustrated in FIG. 6 is a map screen 400 displayed by a conventional automobile navigation system. As illustrated in FIG. 6, roads are extended from an intersection A in the south and north directions and in the east and west directions, and a subject vehicle (corresponding to a vehicle icon 401) mounted with a conventional automobile navigation system is running south of the intersection A toward the north. In addition, another vehicle (corresponding to a vehicle icon 403) mounted with a conventional automobile navigation system is running east of the intersection A toward the west. In cases where the other vehicle transmits communication information in the position indicated by the vehicle icon 403, the conventional automobile navigation system displays the vehicle in the position indicated by the vehicle icon 403. When this map screen 400 is displayed in the subject vehicle, in fact, the other vehicle (corresponding to the vehicle icon 403) does not exist in this position, and it has further moved forward. This is because communication and the like consumes some time, and the vehicle moves forward during this time. Though there is also slight deviation between the position of the subject vehicle (corresponding to the vehicle icon 401) and its actual position, this deviation is negligible because the processing for display is completed within the subject vehicle.

The map screen 410 illustrated in FIG. 7 is a map screen 410 displayed by an automobile navigation system 20 in this embodiment. This is the map screen at the same point in time as in FIG. 6; however, the position where the other vehicle (corresponding to the vehicle icon 415) is closer to the intersection A than in FIG. 6. That is, the other vehicle is displayed in an estimated position shifted from the position of the other vehicle (corresponding to the vehicle icon 415a), indicated by broken line, by an amount LD equivalent to a total delay time. The vehicle icon 415a indicated by broken line is not actually displayed. An oval 417 is depicted around the vehicle icon 415. This oval 417 indicates the error range of the position where the other vehicle exists, and the shape and size of the oval 417 are determined based on the transmitting vehicle position error 218 contained in communication information. Specifically, an error in the longitudinal direction in the transmitting vehicle position error 218 constitutes grounds for the length of the axis of the oval 417 in the east and west directions; and an error in the latitudinal direction in the transmitting vehicle position error 218 constitutes grounds for the length of the axis of the oval 417 in the south and north directions. In cases where it can be presumed that the vehicle is existing on the road (e.g., cases where the vehicle speed is equal to or higher than 30 km/h or other like cases), it is advisable to adjust the shape of the oval so that the error range does not get beyond the road, like the oval 417.

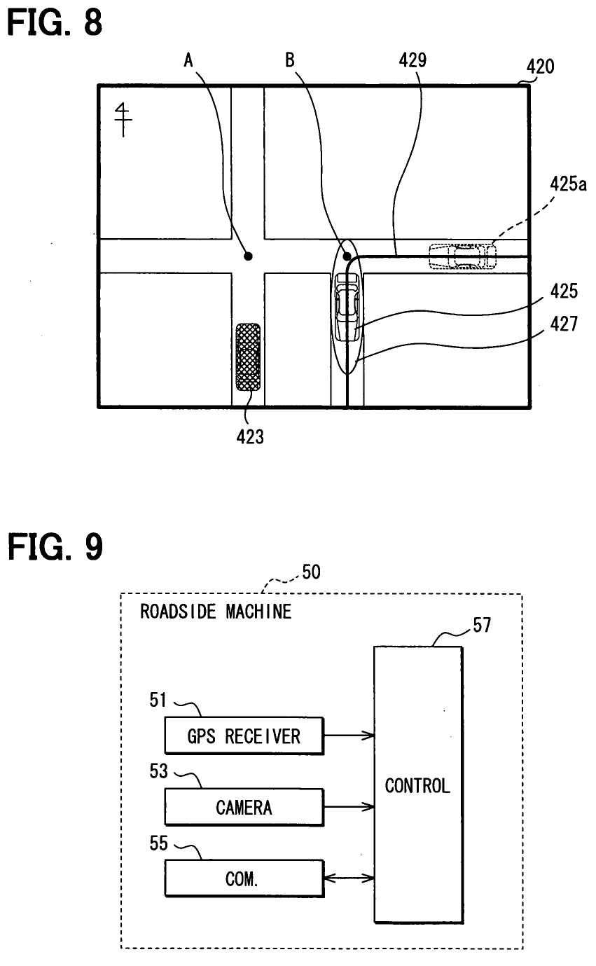

In cases where turn signal lamp information 219h or guided route data 219i is contained in communication information, it is advisable to utilize this information when estimating and displaying the position of the transmitting vehicle. In cases where guided route data 219i is contained in communication information, for example, it is advisable to display the map screen 420 illustrated in FIG. 8. The map screen 420 shows the following situation: roads are extended from an intersection A in the south and north directions and in the east and west directions; and a subject vehicle (corresponding to a vehicle icon 423) mounted with an automobile navigation system 20 in this embodiment is running south of the intersection A toward the north.

It also shows the following situation: another vehicle (corresponding to a vehicle icon 425) mounted with an automobile navigation system 20 in this embodiment is going southward from an intersection B. The communication information utilized to generate this map screen 420 was transmitted by the other vehicle in the place indicated by a vehicle icon 425a. This communication information contains position information (transmitting vehicle position 211) on the place indicated by the vehicle icon 425a, the speed of the other vehicle (transmitting vehicle speed 213), the acceleration of the other vehicle (transmitting vehicle acceleration 215), and the traveling direction of the other vehicle (transmitting vehicle traveling direction 217). In addition, the communication information contains the guided route data 219i associated with route guide that is being carried out in the other vehicle. The position of the other vehicle (corresponding to the vehicle icon 425) is estimated from these information and displayed in the map screen 420.

For this reason, when the map screen 420 is displayed in the subject vehicle, the position of the other vehicle can be more accurately estimated and displayed. An oval 427 indicates the error range of the position where the other vehicle (corresponding to the vehicle icon 425) exists as in the case illustrated in FIG. 7. A line 429 indicates the guided route of the other vehicle (corresponding to the vehicle icon 425) but it is not actually displayed. The vehicle icon 425a indicated by broken line is not actually displayed, either. Here, description has been given to a case where guided route data 219i is contained in communication information. In cases where turn signal lamp information 219h is contained in communication information as well, it is advisable to utilize this information when estimating the position of the other vehicle as in the above example. In cases where a left turn signal lamp is being operated, there is high possibility that immediately after transmitting the communication information, the other vehicle makes a left turn. Thus, it is advisable to take this possibility into account when estimating the position of the other vehicle.

Description will be returned to FIG. 5. At S345, to which the control unit 29 proceeds when it determines that communication information has not been received, the control unit 29 determines whether or not an instruction to terminate operation support has been accepted (S345). That is, the control unit 29 determines whether or not an instruction to terminate operation support, given by the user operating the operation switch group 22 or the remote 23a, has been accepted. In cases where the control unit 29 determines that an instruction to terminate operation support has been accepted (S345: Yes), it proceeds to S350. In cases where the control unit 29 determines that an instruction to terminate operation support has not been accepted (S345: No), it returns to S305.

At S350, to which the control unit 29 proceeds when it determines that an instruction to terminate operation support has been accepted, the control unit 29 terminates the receiving operation started at S325, and further inhibits an interruption for the reception of reference clock time information (S350). Inhibiting an interruption for the reception of reference clock time information refers to bringing the flag indicating whether or not interrupt handling is executable, provided in the control unit 29, into a state of “not executable.” After the completion of these steps, the control unit 29 terminates this processing (reception processing).

Effect of Embodiment

The automobile navigation system 20 in the above-mentioned embodiment is so constructed as to estimate the position of another vehicle when a map screen is displayed before displaying the map screen. That is, the automobile navigation system is so constructed that the influence of delay due to the following is eliminated or reduced: time consumed in processing in the automobile navigation system 20 of the other vehicle; time consumed in communication between the automobile navigation system 20 of the other vehicle and the automobile navigation system 20 of the subject vehicle; time from when the automobile navigation system 20 of the subject vehicle receives communication information to when it generates presented information; and the like. Therefore, the accuracy of the notified position of the other vehicle can be enhanced more than conventional.

The automobile navigation system 20 in the above-mentioned embodiment is so constructed as to estimate the position of any other vehicle using turn signal lamp information 219h or guided route data 219i, transmitted from the other vehicle, as well. For this reason, the position of the other vehicle can be more accurately estimated than in cases where it is estimated only from the speed, acceleration, and traveling direction of the other vehicle.

The automobile navigation system 20 in the above-mentioned embodiment is so constructed as to utilize a signal from a GPS satellite when synchronizing clock times in interrupt handling. For this reason, clock times managed by individual automobile navigation systems 20 accord with one another, and thus the position of any other vehicle can be accurately estimated.

The automobile navigation system 20 in the above-mentioned embodiment is so constructed as to display the error range of the position of any other vehicle by a circle on the display unit 26. For this reason, the user can take the notified error into account when judging the position of the other vehicle, and as a result, the usability of notified information on the position of other vehicles is enhanced.

(Other Embodiments)

(1) The automobile navigation system 20 in this embodiment has the functions of both the sending device and receiving device of the invention. Instead, an automobile navigation system may be so constructed as to have only the functions of the receiving device. The sending device of the invention need not be mounted in a vehicle, and it may be installed at a roadside such as a road shoulder or a sidewalk, or at a position where the sending device can look down at a road. It is especially advisable to install it in a place with an obstructed view or on a black spot for traffic accidents.

Description will be given to a case where a roadside machine installed at a road shoulder has the functions of the sending device of the invention.

FIG. 9 is a block diagram illustrating the general configuration of a roadside machine 50. The roadside machine 50 includes a GPS receiver 51, a camera 53, an external communication instrument 55, and a control unit 57.

The GPS receiver 51 receives a radio wave from a satellite for GPS through a GPS antenna, not shown, and outputs the reception signal to the control unit 57.

The camera 53 shoots vehicles running on the road in proximity to the installed roadside machine 50, and outputs the shot images to the control unit 57. In this embodiment, the camera 53 is used to shoot vehicles running on the nearby road. Instead, any other item may be used. For example, a radar, an optical beacon, various sensors, or the like can be used for this purpose.

The external communication instrument 55 takes on the function of carrying out short-range radio communication with the automobile navigation systems of vehicles running nearby, and utilizes, for example, wireless LAN (IEEE 802.11b/g).

The control unit 57 is constructed based on a publicly known microcomputer composed of CPU, ROM, RAM, SRAM, I/O, bus lines that connect these items, and the like, and carries out various processing based on programs stored in the ROM and the RAM.

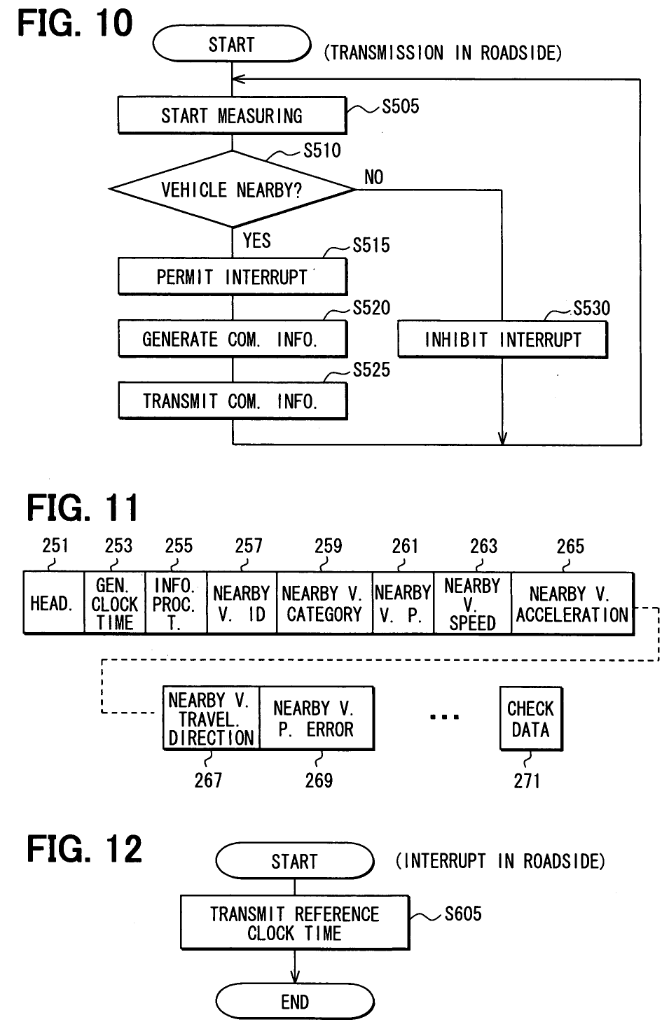

Description will be given to the transmission processing carried out by the control unit 57 with reference to the flowchart in FIG. 10. The execution of transmission processing is started when power supply to the roadside machine 50 is initiated.

After starting the execution of transmission processing, the control unit 57 first starts measuring operation (S505). That is, the control unit 57 starts the processing of causing the camera 53 to function to acquire an image, and extracting a vehicle from the image. A publicly known image processing technology is used for this extraction.

Subsequently, the control unit 57 determines whether or not any vehicle is present nearby (S510). This is done by determining whether or not a vehicle was extracted from the image in the measuring operation started at S505. In cases where the control unit 57 determines that a vehicle was extracted from the image (S510: Yes), it proceeds to S515. In cases where the control unit 57 determines that a vehicle was not extracted from the image (S510: No), it proceeds to S530.

At S515, to which the control unit 57 proceeds when it determines that a vehicle was extracted from the image, the control unit 57 permits an interruption of the transmission of reference clock time information. This is done by bringing a flag indicating whether or not interrupt handling is executable, provided in the control unit 57, into a state of “executable.”

Subsequently, the control unit 57 generates communication information for transmission (S520). The communication information is information about a vehicle existing in proximity to the roadside machine 50, and is intended to implement the following: by transmitting this information to each nearby vehicle, the driver of the vehicle is given information on other vehicles present nearby. Description will be given to a concrete example of this communication information with reference to the data format diagram illustrated in FIG. 11.

FIG. 11 is a data format diagram illustrating the entire communication information. The communication information is composed of header 251, clock time of generation 253, transmission information processing time 255, nearby vehicle ID 257, nearby vehicle category 259, nearby vehicle position 261, nearby vehicle speed 263, nearby vehicle acceleration 265, nearby vehicle traveling direction 267, nearby vehicle position error 269, and check data 271. With respect to the nearby vehicle ID 257 to the nearby vehicle position error 269, a number of sets of them corresponding to the number of vehicles embraced in an image are placed in front of the check data 271.

The header 251 is composed of information required in terms of protocol, information for identifying that the relevant information is communication information, and the like.

The clock time of generation 253 is the clock time when the relevant communication information was generated (more precisely, the clock time at the base point ii in time, described later).

The transmission information processing time 255 is the time that lapsed after the point in time when an image to be used to generate the relevant communication information was received from the camera 53 before the point in time (base point ii in time) when the control unit 57 processed the image and actually set it in the communication information. It is advisable to further add the time of processing in the camera 53 to this elapsed time. These time periods may be actually measured, or a predetermined certain time may be used as these time periods if that time does not vary so much.

The nearby vehicle ID 257 is a unique ID for identifying a nearby vehicle, and, for example, the index number of the vehicle, a random number, or the like can be used as this ID.

The nearby vehicle category 259 is information indicating the category (heavy duty vehicle, ordinary-sized motor vehicle, motorcycle, etc.) of a nearby vehicle. This is determined by reading it from an image.

The nearby vehicle position 261 is information indicating the latitude and longitude of the center point of a nearby vehicle. This is also determined by reading it from an image.

The nearby vehicle speed 263 is the traveling speed of a nearby vehicle. This is determined from a travel distance in the images in different frames and time from frame to frame.

The nearby vehicle traveling direction 267 is information indicating the moving direction of a nearby vehicle, represented by a clock angle with the due north taken as 0 degree. This is also determined by reading it from an image.

The nearby vehicle position error 269 is a position error of a nearby vehicle produced in image processing. It is composed of an error in the latitudinal direction and an error in the longitudinal direction. An error in traveling speed may be added.

The check data 271 is used on the receiving side to confirm that communication information was properly transmitted and received. Communication information is determined to have been properly transmitted and received when it is confirmed on the receiving side that the data, obtained by applying the communication information excluding the check data 271 to a predetermined computational expression on the receiving side, agrees with the check data 271.

Description will be returned to FIG. 10. After the completion of generation of the communication information for transmission, the control unit 57 transmits the generated communication information to nearby vehicles through the external communication instrument 55 (S525). This is done by broadcast. Thereafter, the control unit 57 returns to S505.

At S530, to which the control unit 57 proceeds when it determines that a vehicle was not extracted from an image, the control unit 57 inhibits an interruption for the reception of reference clock time information. Inhibiting an interruption for the reception of reference clock time information refers to bringing the flag indicating whether or not interrupt handling is executable, provided in the control unit 57, into a state of “not executable.” Thereafter, the control unit 57 returns to S505.

Description will be given to the interrupt handling carried out by the control unit 57 with reference to the flowchart in FIG. 12. The execution of interrupt handling is started when the GPS receiver 51 receives GPS information including a clock time and this information is inputted as an interrupt signal to the control unit 57. The interrupt handling is executed only when the flag indicating whether or not interrupt handling is executable, provided in the control unit 57, is in a state of “executable.”

After starting the execution of interrupt handling, the control unit 57 takes the clock time in the satellite out of the GPS information that triggered this processing, and transmits reference clock time information to the automobile navigation systems 20 mounted in nearby vehicles with the taken-out clock time taken as the reference clock time (S605). Then, the control unit 57 terminates this processing (interrupt handling).

The above-mentioned automobile navigation system 20 can be used as a receiving device corresponding to this roadside machine 50 substantially without change. In this case, however, the above-mentioned transmission processing carried out by the automobile navigation system 20 is unnecessary. In reception processing, it is advisable to use the nearby vehicle ID 257 to the nearby vehicle position error 269 in place of the transmitting vehicle ID 207 to the transmitting vehicle position error 218. It is advisable that the interrupt handling (FIG. 4) should be so constructed that a reference clock time transmitted from a roadside machine 50 is set as the clock time on the internal clock, in place of the clock time in a satellite contained in GPS information.

Even an operation support system that includes such a roadside machine 50 as a component produces the same effect as the above-mentioned operation support system composed only of the automobile navigation system 20. An operation support system that includes the roadside machine 50 as a component can implement the following even when in a relevant operation support area, there is no automobile navigation system 20 that transmits information on a nearby vehicle: the operation support system can inform the driver of a vehicle mounted with the automobile navigation system 20 of information on the presence of a vehicle not mounted with the automobile navigation system 20.

(2) The above-mentioned embodiment is so constructed that presented information is generated from communication information and is outputted only when the communication information is received. Even when communication information is not received, it is advisable that presented information should be generated using communication information received in the past and outputted at equal time intervals. That is, in cases where a negative determination is made at S330 in FIG. 5, it is advisable that presented information should be generated from communication information received in the past and the generated presented information be outputted at S340. For the estimation of the current position of a transmitting vehicle, the same method as mentioned above can be used.

With this construction, the following advantage is brought: even if the communication temporarily stops after communication from some other automobile navigation system 20 is started, the current position of the transmitting vehicle is continuously estimated and notified to the user. Therefore, it is unnecessary for the user to view old information and estimate the current position of the transmitting vehicle by him/herself.

(3) For clock time synchronization, the above-mentioned embodiment is so constructed that interrupt handling (FIG. 4) is carried out separately from transmission processing (FIG. 2) and reception processing (FIG. 5). Instead, the invention may be so constructed that the same processing as the interrupt handling (FIG. 4) is carried out during the transmission processing (FIG. 2) or reception processing (FIG. 5). More specific description will be given. In the case of transmission processing, the interrupt handling may be carried out, for example, immediately after the transmission processing is started (before S105) or immediately after measuring operation is started (after S125). In the case of reception processing, the interrupt handling may be carried out immediately after the reception processing is started (before S305) or before the receiving operation is started (before S325).

Also, in a roadside machine 50, interrupt handling need not be carried out as described in relation to FIG. 12, and the same processing as the interrupt handling (FIG. 12) may be carried out during transmission processing (FIG. 10). Specifically, the interrupt handling may be carried out, for example, immediately after when it is determined that there is a vehicle nearby (S510: Yes).

In the above, the navigation system 20 functions as a receiving device in an operation support system and, further, as a sending device in the operation support system. The roadside machine 50 functions as a sending device of an operation support system.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. An operation support system comprising a sending device and a receiving device,
the sending device including:
a situation information acquisition unit configured to acquire information on a situation around the sending device as situation information;
a first communication unit configured to communicate with the receiving device; and
a first control unit configured to
manage a clock time,
add clock time information to identify a true clock time, which is associated with the acquired situation information, to the acquired situation information to compose communication information, and
cause the first communication unit to transmit the composed communication information to the receiving device, and
the receiving device including:
a notifying unit configured to give notification of information;
a second communication unit configured to communicate with the sending device to receive the communication information from the sending device; and
a second control unit configured to
manage a clock time,
make an estimation of situation information at a current clock time from the situation information contained in the received communication information, based on an elapsed time from the true clock time identified by the clock time information contained in the received communication information, and
cause the notifying unit to give notification of the estimated situation information.

2. The operation support system of claim 1, wherein
the acquired information on the situation around the sending device as the situation information includes at least either information on a vehicle, in which the sending device is mounted, or information on a situation around the vehicle.

3. The operation support system of claim 1, wherein
the sending device is provided in a position, from which a road is viewed, and
the acquired information on the situation around the sending device as the situation information includes at least information on a vehicle on the road.

4. The operation support system claim 1,
wherein the second control unit of the receiving device makes the estimation of the situation information at the current clock time further based on time consumed in the estimation.

5. The operation support system of claim 1,
wherein the second control unit of the receiving device makes the estimation of the situation information further based on time required after carrying out the estimation before causing the notifying unit to give the notification of the estimated situation information.

6. The operation support system of claim 1, further comprising:
a guided route information acquisition unit for acquiring guided route information or a turn signal lamp operation information acquisition unit for acquiring information on operation of turn signal lamps,
wherein when the second control unit of the receiving device carries out the estimation, the guided route information acquired by the guided route information acquisition unit or the operation information acquired by the turn signal lamp operation information acquisition unit is taken into account.

7. The operation support system of claim 1,
wherein each of the sending device and the receiving device further includes a clock time synchronizing unit for synchronizing clock times,
wherein the first control unit of the sending device uses clock times synchronized by the clock time synchronizing unit as the clock time information, and
wherein the control second unit of the receiving device uses clock times synchronized by the clock time synchronizing unit when carrying out the estimation.

8. The operation support system of claim 7,
wherein the clock time synchronizing unit of the sending device and the clock time synchronizing unit of the receiving device utilize a signal from a GPS satellite or a signal from an internal clock of a roadside machine when synchronizing clock times.

9. The operation support system of claim 1,
wherein when causing the notifying unit to give the notification of the situation information, the second control unit of the receiving device causes error information associated with the situation information to be notified as well.

10. The operation support system of claim 1,
wherein even when the communication information is not received from the sending device, the second control unit of the receiving device uses communication information previously received so as to carry out the estimation and causes the notifying unit to give the notification of the estimated situation information.

11. A sending device comprising each of the units described in relation to the sending device in the operation support system of claim 1.

12. A receiving device comprising each of the units described in relation to the receiving device in the operation support system of claim 1.

13. A method used for an operation support system including a sending device and a receiving device, the method comprising:
acquiring information on a situation around the sending device as situation information;
managing a clock time in the sending device;
adding clock time information to identify a true clock time, which is associated with the acquired situation information, to the acquired situation information to compose communication information;
transmitting the composed communication information from the sending device to the receiving device;
receiving the communication information in the receiving device;
managing a clock time in the receiving device;
making an estimation of situation information at a current clock time from the situation information contained in the received communication information, based on an elapsed time from the true clock time identified by the clock time information contained in the received communication information; and
giving notification of the estimated situation information.
